(19) United States
(12) Patent Application Publication
(10) Pub. No.: US 2025/0329474 A1
(43) Pub. Date: Oct. 23, 2025

(54) ADVANCED FUEL CYCLE AND FUSION REACTORS UTILIZING THE SAME

(71) Applicant: Helion Energy, Inc., Everett, WA (US)

(72) Inventors: John Thomas Slough, Bellevue, WA (US); David Edwin Kirtley, Seattle, WA (US); Christopher James Pihl, Mill Creek, WA (US)

(73) Assignee: Helion Energy, Inc., Everett, WA (US)

(21) Appl. No.: 19/022,745

(22) Filed: Jan. 15, 2025

Related U.S. Application Data
(63) Continuation of application No. 17/823,463, filed on Aug. 30, 2022, now abandoned.
Application No. 17/823,463 is a division of application No. 15/116,025, filed on Aug. 2, 2016, now Pat. No. 11,469,003.
(60) Provisional application No. 61/937,030, filed on Feb. 7, 2014.

(51) Int. Cl. G21B 1/11

(52) U.S. Cl. CPC G21B 1/115

(57) ABSTRACT

Examples of advanced fuel cycles for fusion reactors are described. Examples include fuel cycles for use in field reverse configuration (FRC) plasma reactors. In some examples, reaction gases may be removed from a fusion reactor between pulses (e.g. plasmoid collisions). In some examples, a D-³He reaction is performed, with the ³He provided from decay of byproducts of previous reactions (e.g. tritium).

### CROSS-REFERENCE TO RELATED APPLICATION(S)

This application is a continuation of pending U.S. patent application Ser. No. 17/823,463 filed Aug. 30, 2022, which is a divisional of U.S. patent application Ser. No. 15/116,025 filed Aug. 2, 2016 and issued as U.S. Pat. No. 11,469,003 on Oct. 11, 2022, which application is a 371 National Stage Application of International Application No. PCT/US15/14904, filed Feb. 6, 2015, which application claims priority U.S. Provisional Application No. 61/937,030, filed Feb. 7, 2014. The aforementioned applications, and issued patent, are incorporated herein by reference, in their entirety, for any purpose.

### TECHNICAL FIELD

Embodiments of the invention relate generally to fusion, and examples of a Helium-3 fuel cycle for a fusion reactor are described.

### BACKGROUND

For many years the notion of thermonuclear fusion for electrical energy production was based on deuterium and tritium fuels where most of the fusion energy is released as 14.1 MeV neutrons. The engineering requirements due to wall loading in a commercial fusion reactor are accordingly difficult to achieve. Advanced fuels have been studied so as to mitigate these engineering problems and possibly find a reasonable reactor system with higher plant efficiency.

The P-11B fuel cycle seems attractive because no neutrons are generated with this fuel cycle, however it must be said that there are side reactions with the fusion products (¹¹B+⁴He→¹⁴N+n+157 keV) that do generate a small but significant neutron component. Nevertheless, the requisite temperature for P-¹¹B fusion is as high as 400 keV. Due to the use of boron, which has a much higher atomic number than helium or hydrogen isotopes, the associated Bremsstrahlung radiation losses are large, and ignition cannot be obtained. The D-³He fusion reaction produces no neutrons as well (D+³He→⁴He (3.6 MeV)+H (14.7 MeV). However the D-D side reaction, while not as frequent, can generate 14.1 MeV neutrons through one of its fusion product reactions (D+T →⁴He+n+14.1 MeV). There is also the D-D reaction itself that produces a lower energy neutron (2.45 MeV) which is below the threshold for activation of most nuclear materials and is thus far less detrimental.

### SUMMARY

Examples of methods and fusion reactors are described herein. Example methods and fusion reactors may be used to extract fusion reaction byproducts from a fusion reactor between pulses.

In some examples, deuterium is supplied to a fusion reactor. A D-D fusion reaction is performed to produce energy, ³He, and tritium byproducts. The fusion reactor is pulsed to remove at least some of the tritium byproducts produced in the D-D reaction prior to a D-T fusion reaction.

³He may be created in some examples through decay of the removed tritium.

In some examples, the fusion reactor is repetitively pulsed.

In some examples, the ³He removed from the fusion reactor is used in subsequent D-D and/or D-³He fusion reactions.

In some examples, the ³He is supplied to the fusion reactor together with additional deuterium.

In some examples, sufficient ³He is provided to the fusion reactor from previous D-D fusion reactions to allow for a self-sustaining D-³He fuel cycle with no external ³He addition.

In some examples, the tritium byproducts are remotely stored.

In some examples, conducting the D-D fusion reaction includes forming at least two plasmoids and accelerating the at least two plasmoids towards one another.

In some examples, conducting the D-D fusion reaction includes raising a temperature of a plasma to 70 keV or less.

In some examples, a lithium blanket is provided for production of additional ³He. In some examples, the method includes storing energy generated during the D-D fusion reaction.

In some example methods, deuterium is received in a fusion reactor. ³He is also received in the fusion reactor, wherein the ³He was generated from byproducts and/or decay of byproducts produced previously in the fusion reactor or another fusion reactor. The deuterium is reacted with the ³He in a fusion reaction, and tritium byproducts of the deuterium and ³He reaction are removed from the fusion reactor.

Some example methods further include decaying the tritium byproducts to produce further ³He.

In some example methods, reacting the deuterium with the ³He comprises accelerating two plasmoids towards one another.

In some example methods, removing tritium byproducts includes pulsing a plasma used in the fusion reaction.

In some example fusion reactors, a plasma formation region is provided for receipt of deuterium and ³He fuel. The fusion reactor is configured for generated plasmoids to be accelerated and compressed toward one another. Example fusion reactors include an interaction chamber where the plasmids may merge and a fusion reaction may occur. Example fusion reactors further include one or more divertors for extraction of byproducts of the fusion reaction. The byproducts may include ³He and/or tritium in some examples.

### BRIEF DESCRIPTION OF THE DRAWINGS

FIG. 1 is a schematic illustration of a portion of a fusion reactor in accordance with examples described herein;

FIG. 2 is an illustration of field lines and pressure contours for an FRC plasmoid obtained from a resistive, two dimensional magneto-hydrodynamic (MHD) code calculation;

FIG. 3 is a schematic illustration of reactions occurring in example D-³He fuel cycles described herein;

FIG. 4 is a graph of helion to deuteron ratio in example fusion plasmas in various modes of operation; and

FIG. 5 is a graph of fractional neutron power as a function of helion-deuteron ratio in the fusion plasma.

### DETAILED DESCRIPTION

Certain details are set forth below to provide a sufficient understanding of embodiments of the invention. However, it will be clear to one skilled in the art that embodiments of the invention may be practiced without various of these particular details. In some instances, well-known circuits, control signals, timing protocols, and software operations have not been shown in detail in order to avoid unnecessarily obscuring the described embodiments of the invention.

Example systems and methods described herein may employ a ³He fuel cycle which may reduce or suppress a dangerous D-T side reaction by extracting the tritium ions as they are created. The extracted tritium is unstable and may beta decay in a relatively short period of 11 years to ³He, a primary fuel for the D-³He reaction. Accordingly, example systems, reactors and methods described herein may enjoy a self-sustaining fuel cycle where the required ³He to operate the reactor may be generated by the decay of tritium ions extracted from the reactor itself. In some examples, a D-D side reaction may be suppressed or reduced by operating a fusion plasma at a higher temperature where a fusion cross-section for D-³He is much larger than D-D.

Example reactors described herein and/or which may be used with fuel cycles described herein generally include systems in which plasmoids are formed and accelerated toward one another. Examples of suitable fusion reactors are described, for example, in International Patent Application No. PCT/US2010/024172, filed Feb. 12, 2010, entitled “Method and apparatus for the generation, heating and/or compression of plasmoids and/or recovery of energy therefrom” (claiming priority to USSN 61/152,221, filed Feb. 12, 2009), U.S. Ser. No. 13/201,428, filed Feb. 12, 2010, entitled “Method and apparatus for the generation, heating and/or compression of plasmoids and/or recovery of energy therefrom,” International Patent Application No. PCT/US2011/047119 (WO/2012/021537), filed Aug. 9, 2011, entitled “Apparatus, systems and methods for establishing plasma and using plasma in a rotating magnetic field” (claiming priority to USSN 61/372,001, filed Aug. 9, 2010), and International Patent Application No. PCT/US2012/063735 (WO/2013/112221), filed Nov. 6, 2012, entitled, “Apparatus, systems and methods for fusion based power generation and engine thrust generation” (claiming priority to USSN 61/556,657, filed Nov. 7, 2011). All of the afore-mentioned patent applications are incorporated herein by reference in their entirety and for any purpose.

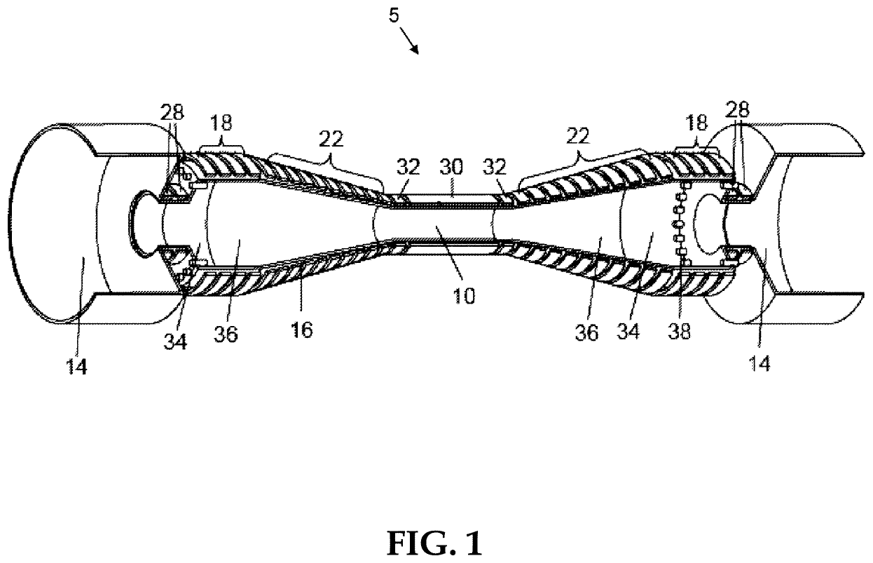

FIG. 1 is a schematic illustration of a portion of a fusion reactor in accordance with examples described herein. The fusion reactor 5 may include an interaction chamber 10 in the center, a formation, accelerator, and compression section 36 on each end of the interaction chamber 10, and a plasmoid formation section 34 next to each accelerator/compression section 36. The fusion reactor 5 may additionally include a divertor 14 on the outer end of each formation section 34. The fusion reactor 5 may also include interaction chamber coils 30, 32 around the outer perimeter of the interaction chamber 10, accelerator coils 22 around the outer perimeter of the acceleration/compression section 36, formation coils 18 around the outer perimeter of formation section 34, and end coils 28 around the outer perimeter of the fusion reactor 5 between the extreme end of each formation section 34 and the respective divertor 14. The fusion reactor 5 may further include an annular array of small plasmoid sources 38 located near a dielectric vacuum tube wall under the first formation/acceleration coil 18 nearest the end coils 28. The chamber wall 16 of the fusion reactor 5 may act as a vacuum boundary.

During operation, the axial array of coils may be energized in a properly sequenced manner to obtain the reactions described herein. Generally, the coil systems may provide for formation, acceleration, and compression of field reversed configuration (FRC) plasmoids to high velocity with respect to one another (e.g. up to 800 km/s). The motional energy of the FRC plasmoids may provide a significant fraction of the energy needed to heat the plasma to fusion temperature. The motional energy may be converted into thermal energy when two FRC plasmoids merge. The formation coils 18 may be supplied with an initial reverse bias. A forward bias is applied to the end coils 28 and the accelerator coils 22, as well as the interaction chamber coils 30, 32. The plasma formation section 34 may be increased in radius to provide for greater initial flux and energy. This is followed at smaller radius by a set of accelerator/compression coils 22 with forward bias increasing as the radius decreases moving toward the interaction chamber 10. A gradual reduction in radius and increase in compression may in some examples result as a plasmoid travels down the acceleration/compression section 36.

The formation coils 18 may be energized sequentially to both form, accelerate, and compress the plasmoids simultaneously. In this manner, plasmoids may be magnetically isolated from the vacuum wall and moved toward and into the interaction chamber where they are merged with their mirror image to form a merged plasmoid that may be compressed to thermonuclear conditions. Accordingly, precise control of the coils may be used to repeatedly drive plasmoids into the interaction chamber from opposite directions, colliding and merging the plasmoids. After one pair has merged, another pair may enter the interaction chamber for merging and thermonuclear reaction. This “pulsing” of collision in the interaction chamber may advantageously allow access to the reaction products (e.g. during a time between collisions in in the interaction chamber), and accordingly allow for removal of tritium formed during a deuterium reaction. The tritium may in some examples be removed between each pulse—e.g. the plasmoids may collide and D-D fusion reactions occur, then tritium byproducts may be removed prior to undesired D-T reactions taking place, then a subsequent plasmoid collision may occur, followed by tritium byproduct removal, etc.

Accordingly, deuterium and ³He may be introduced in some examples to the formation region of the fusion reactor. Byproducts including ³He and tritium may be collected at the divertor region (e.g. divertor 14 of FIG. 1).

The divertor, e.g. divertor 14 of FIG. 1, may serve a variety of purposes. In the divertor region energy and fuel may be extracted from the fusion reaction between pulses. For example, fuel byproducts including hydrogen, deuterium, tritium, Helium-3 (Helion) and Helium-4 (Alpha) particles, or combinations thereof, may be extracted and separated in the divertor region. There are a number of techniques that may be used, and the particular technique in a given example may be selected based on the specific economics of a particular installation. Generally, the extraction techniques take advantage of the fact that the particles all have different mass-to-charge ratios and have a large energy spread. Suitable techniques include but are not limited to cryogenic separation, mass quadrupole separation, inversion-ion cyclotron extraction, and as well as a host of standard chemical processes. Extraction and separation may be done in-situ or at an external location. In this manner, Helium-3 (e.g. ³He) and tritium may be extracted from the byproduct of a fusion reaction and stored. The tritium may decay to ³He. The harvested ³He may be used as fuel for subsequent fusion reactions in the same or a different fusion reactor.

Generally, the repetitively-pulsed nature of example fusion reactors, along with the divertor/converter regions, e.g. 14 of FIG. 1 located remotely from the fusion burn chamber (see e.g. element 10 of FIG. 1), the extraction of tritium can be obtained completely suppressing or reducing this side reaction. The suppression of the D-D reaction can be obtained by raising the plasma temperature to 70 keV which may also assure a self-ignited state which may be appreciably lower than that of other advanced fuel cycles in some examples. By being pulsed, examples of fusion reactors described herein may be capable of removing the tritium byproduct of the D-D reaction with each pulse reducing the high energy neutron (14.1 MeV) generation from the D-T reaction to near zero. This may reduce both the damage and activation the surrounding reactor materials, as well as provide for a source of ³He through the beta decay of the recovered triton into a helion. This fuel cycle can therefore be referred to as Helion Catalyzed D-D through self-supplied ³He, or HelCat-DD.

Accordingly, following a plasma pulse (e.g. plasmoid collision), byproducts of the reaction including ³He and tritium may be removed from the fusion reactor. In some examples, the byproducts may be retained in, e.g. a reservoir, and later processed. Processing of the byproducts may include removal of the ³He and storage of the tritium to allow for decay of the tritium to ³He. ³He removed from the fusion reactor may be used in subsequent fusion reactors in that or a different fusion reactor. Similarly, ³He produced through decay of tritium produced in the fusion reactor may be used in subsequent fusion reactions in that or a different fusion reactor. In this manner, a reactor may be operated in some examples using only ³He that was produced from previous fusion reactions (either directly or through tritium decay in the same or a different fusion reactor).

Once the initial fuel supply is established in some examples of fusion reactors described herein, the only new fuel which may be required for continued operation may be deuterium which is abundant on earth, and can be readily supplied from water from any source. With primarily all of the fusion energy in the form of fusion particle energy, a high net plant electrical generation efficiency can be obtained from direct conversion of both the fusion product and fusion plasma particles in some examples. This may be accomplished through the electromagnetic compression and expansion cycle employed to create the fusion conditions and thus may avoid the low efficiency and waste heat issues typically found in the usual thermal cycle employed by other nuclear and carbon based power sources.

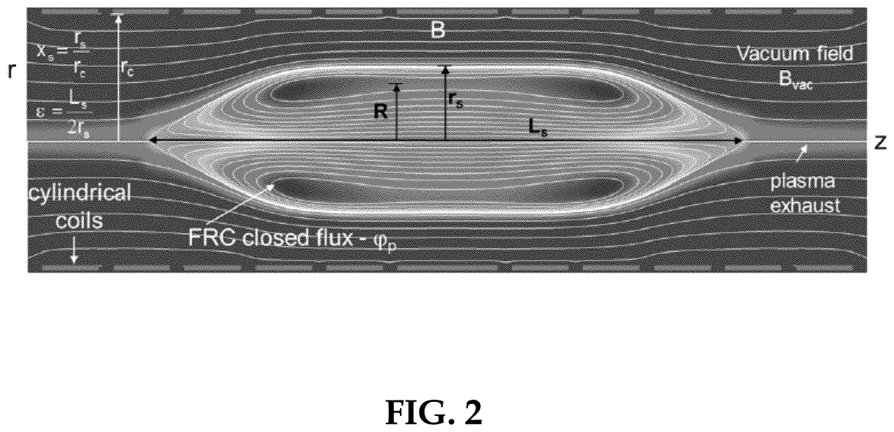

There may be several advantages of example implementations of the D-³He fuel cycle combined with the Field-Reversed Configuration (FRC) fusion plasma generated in example fusion reactors described herein. Advantages are described herein by way of example and are not intended to be limiting. It is to be understood that not all examples may display all, or even any, of the described advantages. The FRC represents a promising magnetic confinement system for fusion regardless of fuel cycle. FIG. 2 is an illustration of field lines and pressure contours for an FRC plasmoid obtained from a resistive, two dimensional magneto-hydrodynamic (MHD) code calculation. The FRC plasmoid generally has no internal mechanical structure, no appreciable toroidal field or rotational transform, and an engineering beta near unity (where β is the ratio of plasma to confining magnetic field energy density). The equilibrium current is due generally to the plasma diamagnetism thereby avoiding or reducing the current driven instabilities that plague other fusion concepts. Plasma loss at the FRC edge generally occurs across a magnetic separatrix ensuring that the lost plasma is conducted far away from the burn region to a remote chamber where both the plasma and fusion particle energy can be directly converted to electricity at high efficiency. As a result of these features, the FRC offers a transformational change in reactor attractiveness. Example FRC based fusion reactors provide generally for high power density, simple structural and magnetic topology, straightforward heat exhaust handling, capability to burn advanced fuels for direct energy conversion, and radically reduced costs, due at least in part to their small size and low neutron fluence.

A significant issue for magnetically confined plasmas is synchrotron radiation as the magnetic field strength is increased to attain the higher temperatures and pressures required for advanced fuel cycles such as D-³He. Devices such as the tokamak which have a relatively small plasma pressure compared to the large magnetic pressure needed to confine the plasma (β˜4%), cannot operate on advanced fuels due to the high energy loss from synchrotron radiation. To be viable, the local value of β, the ratio of plasma to magnetic energy density, must generally be high as this assures that inside the plasma the magnitude of the magnetic field is never large enough to cause significant synchrotron losses. Due to the high B nature of the FRC equilibrium, essentially all of the reacting volume of the FRC is characterized by a magnetic field of very low to negligible field strength, and thus an insignificant amount of synchrotron radiation.

A practical problem faced by the D-³He fuel cycle is the low availability of ³He in nature. To avoid this difficulty, the helion (³He) in examples described herein is created either directly or through the decay of tritium produced in the D-D reaction. In this manner the helion ions needed for the operation of the reactor are supplied by the D-D side reactions. This fuel cycle can therefore be referred to as Helion Catalyzed D-D through self-supplied ³He, or HelCat-DD. In this manner, once plant operation is established, the only new fuel required for continued operation in some examples is deuterium with all or substantially all the helion atoms coming from those produced directly in the D-D reaction or from the decay of the tritons removed from the reactor after each pulse.

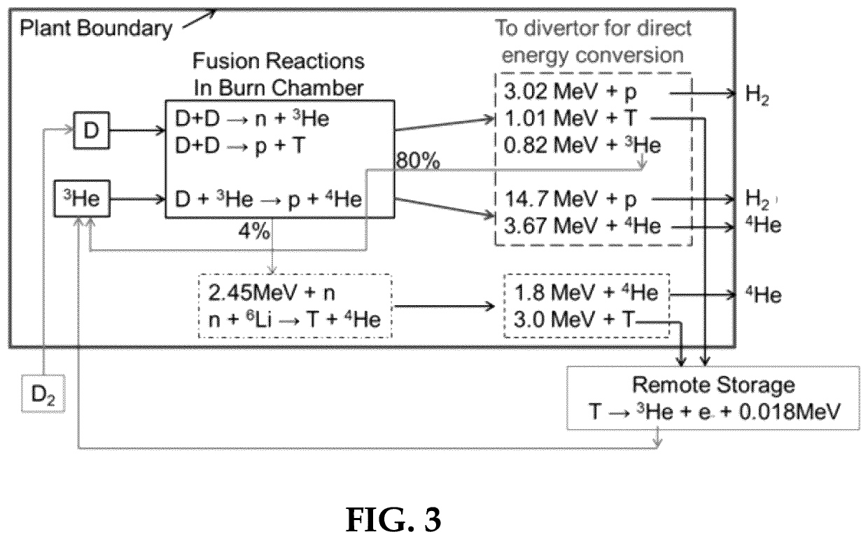

FIG. 3 is a schematic illustration of reactions occurring in example D-³He fuel cycles described herein. During operation, Deuterium (D) and ³He may be provided to a fusion reactor (e.g. to the reactor 5 of FIG. 1). In the burn chamber (e.g. interaction chamber 10 of FIG. 1), D and ³He may react as shown to produce protons and ⁴He. In the divertor (e.g. divertor 14 of FIG. 1), energy conversion may occur yielding 3.02 MeV protons, 1.01 MeV tritons and 0.82 MeV ³He. The ³He may be removed from the divertor and returned to the fusion reactor for use in reacting with additional incoming Deuterium. The tritons may be removed from the divertor and allowed to decay in a remote storage location. In some examples, the storage location need not be remote. The tritons may decay to ³He and 0.018 MeV electrons. The ³He may be provided back to the fusion reactor for use in subsequent D-³He reactions. Side D+D reactions in the burn chamber may produce neutrons and ³He as well as protons and tritons. In the divertor, these side reactions may yield 14.7 MeV protons and 3.67 MeV ⁴He.

In some examples, a lithium blanket may be provided (e.g. in or around the interaction chamber 10 of FIG. 1). As shown in FIG. 3, the Deuterium reactions may further produce 2.45 MeV neutrons, which may react with lithium ⁶Li to form tritons and ⁴He. At the divertor, this may yield 1.8 MeV ⁴He and 3.0 MeV tritons. The tritons may be transported out of the fusion reactor and may decay to ³He which may be used in subsequent reactions by the fusion reactor.

Accordingly, generally Deuterium may be provided to a reactor. Some ³He may be provided to initialize the reactor in some examples. In some examples, subsequent ³He may be provided by decay of reactor products. Fusion reactions take place by sequentially accelerating and compressing plasmoids until they are merged in an interaction chamber. Following merging of the plasmoids, reaction products including tritons may be removed from the fusion reactor and allowed to decay. The removal may occur after each pulse (e.g. plasmoid merging) of the reactor in some examples.

While the reaction cross section can be as large for D-³He operation as the D-T fuel cycle, it must generally be obtained at increased plasma temperature, T. The plasma pressure Ppl scales linearly with T. As noted, this requires a larger confining magnetic field, B (Ppl˜B²). For devices such as the tokamak, which already require operation at near the maximum practical field that can be obtained for superconducting magnets (B˜15 T), the magnetic field cannot generally be further increased. The consequence is that the plasma density, n, must be lowered (Ppl˜n·T). The fusion power scales as n² so that the reactor volume, and with it cost, must increase dramatically to produce the same output power. Example fusion reactors described herein, however, employ the FRC as the fusion plasma. Fusion power density then scales as β²B⁴. The FRC may in some examples have the highest β of all magnetic fusion plasmas and may be contained in some examples by simple cylindrical magnets that can be operated at the highest practical fields. Repetitive operation of pulsed fields up to 30 T with conventional copper alloy coils may be performed in some examples. Having a much higher power density in some examples aids in maintaining the output power from fusion when employing the HelCat DD cycle, and only in the pulsed FRC compression cycle found in example fusion reactors can the power be maintained, and even increased with the HelCat DD advanced fuel cycle due to the much reduced neutron wall loading. By being compact, the ratio of reacting volume to receiving surface area may also be minimized or reduced, allowing for operation at the higher power density. By being pulsed, the pulse duration can be extended or the repetition rate increased to maintain the fusion output power at the highest levels consistent with heat removal.

Parameters of the fusion plasma may be selected to ensure or promote a low neutron yield and high efficiency for energy production. The parameters may be based on the steady state value of the relative quantities of each fuel element (D and ³He). Variants of the D-³He cycle with ³He self-supply are also possible. With primarily all of the fusion energy in the form of fusion particle energy a high net plant thermal efficiency can be obtained from converting much of the fusion power by direct conversion. The low neutron energy yield may also afford a lower cost of first wall and shield structures in some examples. It may also provide for higher plant availability and operating life due to the lower wall loading, afterheat, and radioactive isotope inventory in some examples.

An attribute of example fusion reactors described herein is relatively easy access to the fusion products in the exhaust gas stream after each pulse (e.g. merging of plasmoids). This allows for the selective removal of fusion products. In examples, the charged fusion products, ³He and T included, may be moderated in the plasma releasing their energy to it. This allows for direct energy conversion in the burn chamber from plasma expansion and subsequent flux driven energy conversion. The removed T may be stored and the ³He that is obtained may be used to supply one of the D-³He fuel components. Examples of this type of operation may have advantages when compared to steady state systems, or systems where there is no easy access to the fusion byproducts.

First, the tritons created generally have no time for interaction with D, which allows one to obtain a larger amount of ³He. Second, since the D-T reaction is generally negligible, the neutron flux to the first wall is reduced compared with in situ consumption of the triton. The reduction is in large part due to the elimination of the most dangerous high-energy neutrons created by the D-T reaction (Eₙₑᵤₜ=14.1 MeV).

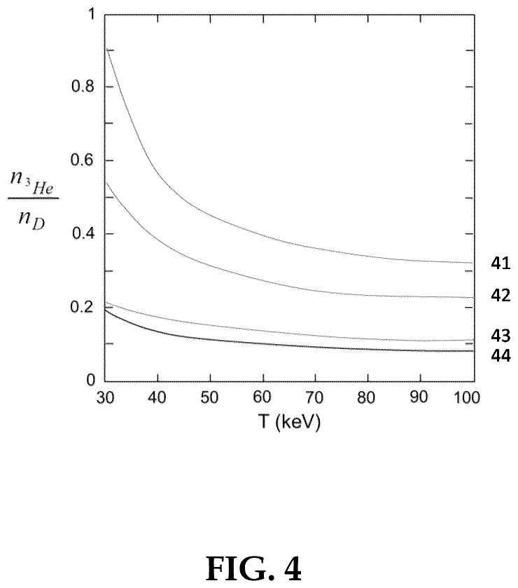

In some examples, the neutron born in the D-D reaction (see FIG. 3) can be used to create additional helions through tritium production in the presence of lithium in the blanket. In such examples, the ³He and T produced in the FRC plasma may also be used. Generally, the two D-D fusion reactions in FIG. 3 serve mainly for the production of ³He and T (this also applies to the secondary reactions with the fusion neutrons if desired). This part of the cycle eventually may provide the ³He to complete the cycle where the overwhelming fraction of the fusion energy generated is provided by the reaction of D with ³He. The effect of the different operating cycles on the steady state fraction of ³He is shown in FIG. 4. It is clear from this plot that the helion to deuteron ratio is greatly enhanced at low plasma temperature due to the relative increase in D-D reactions. Neutron conversion into tritium for decay into ³He is readily accomplished with a natural lithium blanket (7.56% ⁶Li, remainder ⁷Li) where the reaction ⁷Li+n→T+⁴He+n−2.47 MeV produces a second neutron assuring a total ³He yield per D-D neutron greater than one (up to a maximum of 1.9).

FIG. 4 is a graph of helion to deuteron ratio in example fusion plasmas in various modes of operation. Line 44 illustrates a mode where ³He is produced primarily or only in the D-D reaction. Line 43 illustrates a mode where ³He is produced in the D-D reaction along with ³He decay of T from the D-D reaction. Line 42 illustrates a mode where a Li blanket is provided such that each neutron may produce one triton. Line 41 illustrates a mode where each neutron may produce 1.9 tritons.

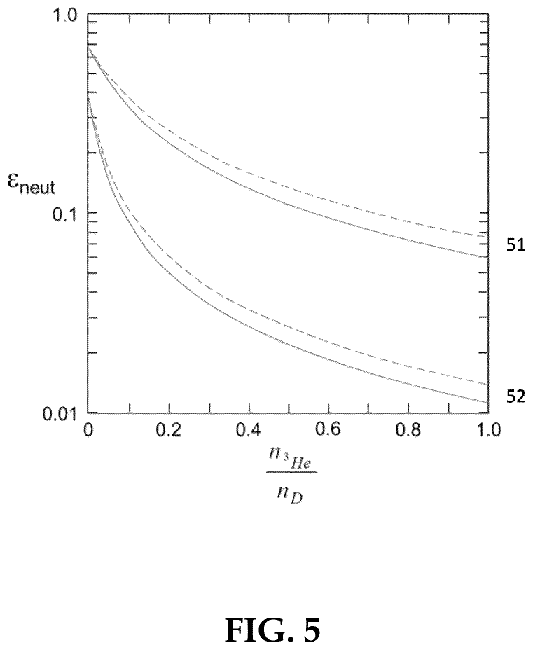

While a relatively low plasma temperature provides for the highest fractional levels of ³He, it does not necessarily provide for the best suppression of the neutron energy (lowest fraction of neutron power to total fusion power, εₙₑᵤₜ) or the highest conversion efficiency (highest fraction of particle to total fusion power, εₚₐᵣₜ). Insight into what is the most favorable operating condition is provided by the dependence of εₙₑᵤₜ on both plasma temperature and helion to deuterium ratio. A plot reflecting these tradeoffs is found in FIG. 5.

FIG. 5 is a graph of fractional neutron power as a function of helion-deuteron ratio in the fusion plasma. The dashed lines indicate 50 keV plasma while the solid lines are for 70 keV. The lines 51 pertain to examples where the tritium produced in D-D reactions cannot be removed. The lines 52 reflect tritium removal after each pulse in the fusion reactor. The graph illustrates an example of the role of tritium removal in reducing neutron exposure regardless of the helion to deuteron ratio. While the sensitivity to plasma temperature is not great, the lower temperature plasmas suffer more substantial losses from Bremsstrahlung radiation. The ratio of Bremsstrahlung power loss to total fusion power produced, ε_{brem} scales as T2 over this range of plasma temperatures which greatly favors the higher temperatures in addition to the lower neutron power with temperature.

An example of results of optimization for an example fusion engine yield the basic plasma parameters found in the below table which provides example parameter values in each of three modes of operation—(1) D-D without tritium removal; (2) D-D with tritium removal; and (3) D-D with tritium removal and lithium blanket.

TABLE 1

| | | | Cat D-D |
|---|---|---|---|
| | | Cat D-D | (T removal w |
| Parameter | Cat D-D | (T removal) | Li blanket) |
| ³He/D | 0.125 | 0.158 | 0.245 |
| n_{T}/n_{D} | 0.006 | ~10⁻³ | ~10⁻³ |
| n_{D} (10²² m⁻³) | 0.75 | 0.75 | 0.62 |
| nₜₒₜ (10²² m⁻³) | 1.95 | 1.88 | 1.72 |
| Tₗ = Tₑ (keV) | 70 | 70 | 70 |
| B (T) | 22 | 22 | 22 |
| τ (s) | 0.157 | 0.103 | 0.088 |
| ε_{brem} | 0.25 | 0.23 | 0.22 |
| εₙₑᵤₜ | 0.27 | 0.06 | 0.04 |
| P_{fus} (MW) (@ 1 Hz) | 72 | 72 | 72 |

Reviewing the table, operation with tritium removal may be considerably more preferable than operation without tritium removal. The wall loading alone would restrict operation to less than 25 MW in this example as a reduction in pulse rate may be required to limit excessive wall loading. The fusion reactor could be operated with or without ³He generation with the D-D neutrons. The decision between these two modes will most likely reflect the cost of the additional technology, although it would appear to be a fairly straight forward use of bulk lithium in a simple, removable blanket. As the advantage is not large, the extra ³He could be used for startup of new fusion reactors if needed. Either way example tritium-suppressed, self-supplied fusion reactors employing D-³He fuel cycles described herein may make for a sweeping advance toward a carbon-free, safe and efficient method for electricity generation from fusion.

From the foregoing it will be appreciated that, although specific embodiments of the invention have been described herein for purposes of illustration, various modifications may be made without deviating from the spirit and scope of the invention.

1. (canceled)

2. A method comprising:
receiving deuterium in a fusion reactor;
receiving ³He in the fusion reactor, wherein the ³He was generated from byproducts produced previously in the fusion reactor or another fusion reactor;
pulsing the reactor causing fusion reactions including reacting the deuterium with the ³He (D-³He) and reacting the deuterium with the deuterium (D-D); and
removing at least some byproducts of the fusion reactions including tritium byproducts and ³He byproducts.

3. The method of claim 2 further comprising decaying the tritium byproducts to produce further ³He.

4. The method of claim 3, wherein the decaying occurs at a location remote from the fusion reactor.

5. The method of claim 2, wherein performing the fusion reactions comprises accelerating two plasmoids towards one another.

6. The method of claim 2, further comprising:
pulsing a plasma to perform the fusion reactions; and
removing the byproducts responsive to pulsing the plasma.

7. The method of claim 2, further comprising providing a lithium blanket to generate further ³He.

8. The method of claim 2, further comprising:
generating the tritium byproducts and the ³He byproducts from the D-D fusion reactions; and
providing the ³He byproducts, ³He generated from decay of the tritium byproducts, or combinations thereof as the received ³He to the fusion reactor, wherein sufficient ³He is provided to the fusion reactor from previous of the D-D fusion reactions to allow for a self-sustaining D-³He fuel cycle.

9. The method of claim 2, further comprising capturing energy generated during the fusion reaction.

10. The method of claim 2, wherein a plasma used to conduct the fusion reaction has a temperature where a fusion reactivity for D-³He is greater than a fusion reactivity for D-D.

11. A method comprising:
supplying deuterium to a fusion reactor containing ³He;
pulsing the fusion reactor by accelerating a first plasmoid and a second plasmoid towards each other to ignite at least a portion of the deuterium and the ³He, causing fusion reactions including deuterium-³He (D-³He) fusion reactions and deuterium-deuterium (D-D) fusion reactions to produce reaction products comprising ³He and tritium byproducts; and
removing, responsive to the pulsing of the fusion reactor, at least some of the tritium byproducts from the fusion reactor,
wherein the at least some of the tritium byproducts are produced by the fusion reactor during the D-D fusion reactions.

12. The method of claim 11, further comprising:
storing the removed at least some tritium byproducts;
allowing the stored tritium byproducts to decay to ³He; and
supplying the ³He from the decay of the stored tritium byproducts to the fusion reactor or another fusion reactor.

13. The method of claim 11, wherein at least some of the ³He contained in the fusion reactor is a byproduct of a previous D-D fusion reaction in the fusion reactor.

14. The method of claim 11, further comprising capturing energy generated during the fusion reaction.

15. The method of claim 11, further comprising separating the at least some tritium byproducts from other byproducts.

16. The method of claim 11, wherein the ³He contained in the fusion reactor is a byproduct of fusion reactions in the fusion reactor or another fusion reactor.

17. The method of claim 11, further comprising suppressing deuterium-tritium (D-T) reactions in the fusion reactor by removing the at least some of the tritium byproducts from the fusion reactor.

18. A method comprising:
supplying deuterium and ³He to a fusion reactor;
conducting fusion reactions including deuterium-³He (D-³He) fusion reactions and deuterium-deuterium (D-D) fusion reactions to produce reaction products comprising ³He and tritium byproducts;
pulsing the fusion reactor; and
removing, responsive to the pulsing of the fusion reactor, at least some of the tritium byproducts from the fusion reactor to reduce deuterium-tritium (D-T) reactions in the fusion reactor,
wherein the at least some of the tritium byproducts that are removed are produced by the fusion reactor during the D-D fusion reactions.

19. The method of claim 18, wherein the tritium is removed from the fusion reactor to decay and create ³He.

20. The method of claim 18, wherein the tritium removed from the reactor is allowed to decay into ³He, which is subsequently supplied to the fusion reactor together with additional deuterium.

21. The method of claim 20, wherein the ³He supplied to the fusion reactor comprises ³He from previous D-D fusion reactions to allow for a self-sustaining D-³He fuel cycle.

22. The method of claim 18, further comprising storing the tritium byproducts in a location remote from the fusion reactor.

23. The method of claim 18, wherein conducting the D-D fusion reactions comprises forming at least two plasmoids and accelerating the at least two plasmoids towards one another.

24. The method of claim 18, further comprising providing a lithium blanket for production of additional ³He.

25. The method of claim 18, wherein the tritium byproducts are removed between pulses of the fusion reactor.

26. The method of claim 18, further comprising suppressing the D-D reaction based on a temperature at which the fusion reactions are performed.

27. The method of claim 18, further comprising performing the fusion reactions at a temperature where a fusion reactivity for D-³He is greater than a fusion reactivity for D-D.

28. The method of claim 18, further comprising removing, responsive to the pulsing of the fusion reactor, at least some of the ³He byproducts.

29. The method of claim 28, further comprising supplying the removed ³He as fuel for subsequent fusion reactions.
